(19) United States
(12) Patent Application Publication
(10) Pub. No.: US 2012/0089758 A1
(43) Pub. Date: Apr. 12, 2012

(54) System On Chip Keeping Load Balance And Load Balancing Method Thereof

(75) Inventors: Jaegeun Yun, Hwaseong-si (KR); Bub-chul Jeong, Yongin-si (KR); Junhyung Um, Seoul (KR); Hyun-Joon Kang, Hwaseong-si (KR); Sung-Min Hong, Hwaseong-si (KR); LIAOLINGLING, Yongon-si (KR)

(73) Assignee: SAMSUNG ELECTRONICS CO., LTD., Suwon-si (KR)

(21) Appl. No.: 13/178,666

(22) Filed: Jul. 8, 2011

(30) Foreign Application Priority Data
Oct. 12, 2010 (KR) 10-2010-0099450

(51) Int. Cl. G06F 13/00

(52) U.S. Cl. 710/110

(57) ABSTRACT

At least one example embodiment discloses a System on Chip (SoC). The SoC includes a master block, a plurality of slave blocks configured to operate in response to a request from the master block, and an interconnect block configured to deliver transactions occurring in the master block to the plurality of slave blocks through a plurality of transfer paths. The interconnect block is configured to monitor load information of the plurality of transfer paths and select one of the plurality of transfer paths according to the load information.

### CROSS-REFERENCE TO RELATED APPLICATIONS

This U.S. non-provisional patent application claims priority under 35 U.S.C. §119 of Korean Patent Application No. 10-2010-0099450, filed on Oct. 12, 2010, the entire contents of which are hereby incorporated by reference.

### BACKGROUND

The present disclosure herein relates to a System on Chip (SoC), and more particularly, to a SoC supporting a multi-layer bus.

A SoC is a technology that integrates a complex system having various functions into a single semiconductor chip. As integrated computer, communication, and broadcasting technologies converge, a demand for Application Specific Integrated Circuit (ASIC) and Application Specific Standard Product (ASSP) shifts into the SoC. Additionally, a tendency for miniaturization and light weight of Information Technology (IT) devices promotes SoC related industries.

The SoC includes an Intellectual Property (IP) block. IP blocks perform specific functions in the SoC. Generally, these IP blocks are connected through a bus. An example standard bus specification for connection and management of the IP blocks in the SoC is an Advanced Microcontroller Bus Architecture (AMBA) of Advanced RISC Machine (ARM) Ltd. A bus type of the AMBA includes an Advanced High-Performance Bus (AHB), an Advanced Peripheral Bus (APB), and an Advanced eXtensible Interface (AXI).

### SUMMARY

At least one example embodiment provides a System on Chip (SoC) maintaining load balance when at least one master block provides a distributed approach to a plurality of slave blocks and a method of maintaining the load balance thereof.

At least one example embodiment of inventive concepts provides SoCs including a master block, a plurality of slave blocks configured to operate in response to a request from the master block, and an interconnect block configured to deliver transactions occurring in the master block to the plurality of slave blocks through a plurality of transfer paths. The interconnect block is configured to monitor load information of the plurality of transfer paths and select one of the plurality of transfer paths according to the load information.

In at least some example embodiments, the interconnect block may include a first monitoring unit configured to monitor load information of a first transfer path among the plurality of transfer paths and generate a first busy signal based on the load information of the first transfer path, a second monitoring unit configured to monitor load information of a second transfer path among the plurality of transfer paths and generate a second busy signal based on the load information of the second transfer path, and a load balancing unit configured to select one of the first and second transfer paths according to the first and second busy signals.

In at least some example embodiments, the load balancing unit is configured to select the second transfer path if the first busy signal is activated and select the first transfer path if the second busy signal is activated.

In at least some example embodiments, the load balancing unit may include a transfer history register configured to store ID information and read/write information about the transactions, and select one of the first and second transfer paths based on the ID information or the read/write information if the first and second busy signals are all activated or deactivated.

In at least some example embodiments, the interconnect block may include an interleaving block configured to transmit the transactions to a slave block selected based on a transaction address among the plurality of slave blocks.

In at least some example embodiments, the master block is configured to output the transactions through a dual port.

In at least some example embodiments of inventive concepts, SoCs include a master block, a plurality of slave blocks configured to operate in response to a request of the master block, and an interconnect block configured to connect the master block with the plurality of slave blocks. The interconnect block includes, a load balancing unit configured to deliver transactions transmitted from the master block to a transfer path selected according to first and second busy signals among first and second transfer paths, a first monitoring unit configured to generate the first busy signal based on load information of the first transfer path, a second monitoring unit configured to generate the second busy signal based on load information of the second transfer path, and an interleaving block configured to transmit transactions delivered from the load balancing unit through the first and second transfer paths to a slave block selected based on a transaction address among the plurality of slave blocks.

In at least some example embodiments, the load balancing unit may include a control logic circuit configured to generate a control signal in response to the first and second busy signals, and interface modules configured to deliver transactions transmitted from the master block to a transfer path selected according to the control signal among the first and second transfer paths.

In at least some example embodiments, the load balancing unit is configured to select the second transfer path if the first busy signal is activated and the second busy signal is deactivated, and select the first transfer path if the first busy signal is deactivated and the second busy signal is activated.

In at least some example embodiments, the load balancing unit may further include a transfer history register configured to store ID information and read/write information about transactions delivered through the selected transfer path.

In at least some example embodiments, the control logic circuit is configured to generate the control signal based on the ID information or the read/write information if the first and second busy signals are activated or deactivated.

In at least some example embodiments, the load balancing unit may further include a re-order buffer configured to store transactions, which are delivered not matching to a response order for a request of the master IP block, in the interface module through the first and second transfer paths.

In at least some example embodiments, the interface module is configured to transmit the transactions stored in the re-order buffer to the master block in a matching response order about the request of the master block.

In at least some example embodiments, the master block is configured to transmit transactions to the interface module through a dual port.

In at least some example embodiments, each of the plurality of slave blocks includes a memory controller.

In at least some example inventive concepts, load balance maintaining methods of a SoC delivering transactions occurring in a master block to a plurality of slave blocks through first and second transfer paths include monitoring load information of the first transfer path and load information of the second transfer path, generating a first busy signal based on the load information of the first transfer path, generating a second busy signal based on the load information of the second transfer path, and selecting one of the first and second transfer paths according to the first and second busy signals.

In at least some example, the selecting one of the first and second transfer paths may include: selecting the second transfer path while the first busy signal is activated and the second busy signal is deactivated, and selecting the first transfer path while the first busy signal is deactivated and the second busy signal is activated.

In at least some example embodiments, the methods may further include storing ID information and read/write information about transactions delivered through the selected transfer path.

In at least some example embodiments, the selecting one of the first and second transfer paths may include selecting one of the first and second deliver paths based on the ID information or the read/write information while the first and second busy signals are all activated or deactivated.

At least some example embodiments disclose a system on chip (SoC) including at least one master block configured to generate a request, an interconnect block including at least first and second transfer paths, the interconnect block configured to receive the request and transmit the request over one of the first and second transfer paths based on load information of the first and second transfer paths, the load information indicating an amount of traffic on the first and second transfer paths and at least one slave block configured to receive the request from the interconnect block.

### BRIEF DESCRIPTION OF THE DRAWINGS

The accompanying drawings are included to provide a further understanding of inventive concepts, and are incorporated in and constitute a part of this specification. The drawings illustrate example embodiments of inventive concepts and, together with the description, serve to explain principles of inventive concepts. In the drawings:

FIG. 1 is a block diagram illustrating a System on Chip (SoC) according to an example embodiment of inventive concepts;

FIG. 2 is a block diagram illustrating an example embodiment of the SoC of FIG. 1 in more detail;

FIG. 3 is a block diagram illustrating a load balancing unit shown in FIG. 2 according to an example embodiment;

FIG. 4 is a block diagram illustrating first and second monitoring units and shown in FIG. 2 according to an example embodiment;

FIG. 5 is a block diagram illustrating another example embodiment of the SoC of FIG. 1 in more detail;

FIG. 6 is a block diagram illustrating a load balancing unit of FIG. 5 according to an example embodiment;

FIGS. 7 and 8 are flowcharts illustrating a method of maintaining a load balance of a SoC according to an example embodiment of inventive concepts; and

FIG. 9 is a block diagram of a memory system including a SoC according to an example embodiment of inventive concepts.

### DETAILED DESCRIPTION OF EXAMPLE EMBODIMENTS

Various example embodiments will be described more fully hereinafter with reference to the accompanying drawings, in which some example embodiments are shown. Inventive concepts may, however, be embodied in many different forms and should not be construed as limited to the example embodiments set forth herein. Rather, these example embodiments are provided so that this disclosure will be thorough and complete, and will fully convey the scope of the inventive concepts to those skilled in the art. In the drawings, the sizes and relative sizes of elements may be exaggerated for clarity. Like numerals refer to like elements throughout.

It will be understood that, although the terms first, second, third etc. may be used herein to describe various elements, these elements should not be limited by these terms. These terms are used to distinguish one element from another. Thus, a first element discussed below could be termed a second element without departing from the teachings of inventive concepts. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular example embodiments only and is not intended to be limiting of the inventive concepts. As used herein, the singular forms “a,” “an” and “the” are intended to include the plural forms as well, unless the context clearly indicates otherwise. It will be further understood that the terms “comprises”, “comprising”, “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which these inventive concepts belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

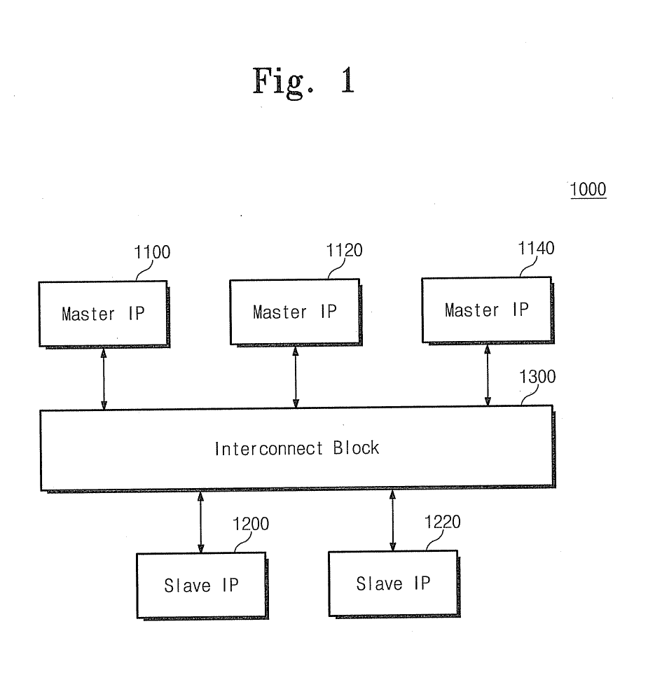

FIG. 1 is a block diagram illustrating a System on Chip (SoC) according to an example embodiment of inventive concepts. Referring to FIG. 1, the SoC 1000 includes a plurality of master Intellectual Property (IP) blocks 1100, 1120, and 1140, a plurality of slave IP blocks 1200 and 1220, and an interconnect block 1300. Although three master IP blocks 1100, 1120, and 1140 and two slave IP blocks 1200 and 1220 are shown in the drawing, the number of master and slave IP blocks connected to the interconnect block 1300 may vary. Moreover, the interconnect block 1300 for connecting the master IP blocks 1100, 1120, and 1140 with the slave IP blocks 1200 and 1220 may also be referred to as a backbone, a system bus, and a network among other terms.

The master IP blocks 1100, 1120, and 1140 may be realized with a central processing unit (CPU), a microcontroller, a microprocessor, and a digital signal processor (DSP). The master IP blocks 1100, 1120, and 1140 may be referred to as master processing blocks. Especially, when the SoC 1000 is applied to a mobile device, the master IP blocks 1100, 1120, and 1140 may be an application chip, an image processor, an audio codec, and/or a mobile station modem. The master IP blocks 1100, 1120, and 1140 transmit transactions to the slave IP blocks 1200 and 1220 via the interconnect block 1300. Here, the transactions may include address information, control information, and data.

The slave IP blocks 1200 and 1220 may be realized with a memory controller controlling an external memory device. The slave IP blocks 1200 and 1220 operate in response to requests of the master IP blocks 1100, 1120, and 1140. The slave IP blocks 1200 and 1220 may be referred to as slave processing blocks.

The interconnect block 1300 connects the master IP blocks 1100, 1120, and 1140 with the slave IP blocks 1200 and 1220. The interconnect block 1300 performs functions of an arbiter and a decoder. That is, the interconnect block 1300 mediates bus resource usage between the master IP blocks 1100, 1120, and 1140 and the slave IP blocks 1200 and 1220. Also, the interconnect block 1300 decodes addresses of the slave IP blocks 1200 and 1220 that the master IP blocks 1100, 1120, and 1140 approach.

The interconnect block 1300 supports a multi-layer bus. Accordingly, transaction transfer paths between the master IP blocks 1100, 1120, and 1140 and the slave IP blocks 1200 and 1220 may be diversely configured.

According to an example embodiment of inventive concepts, when at least one of the master IP blocks 1100, 1120, and 1140 transmits transactions to the plurality of slave IP blocks 1200 and 1220 through respectively different transfer paths in the interconnect block 1300, the interconnect block 1300 may maintain a load balance between transfer paths by selecting a transfer path according to a monitored result.

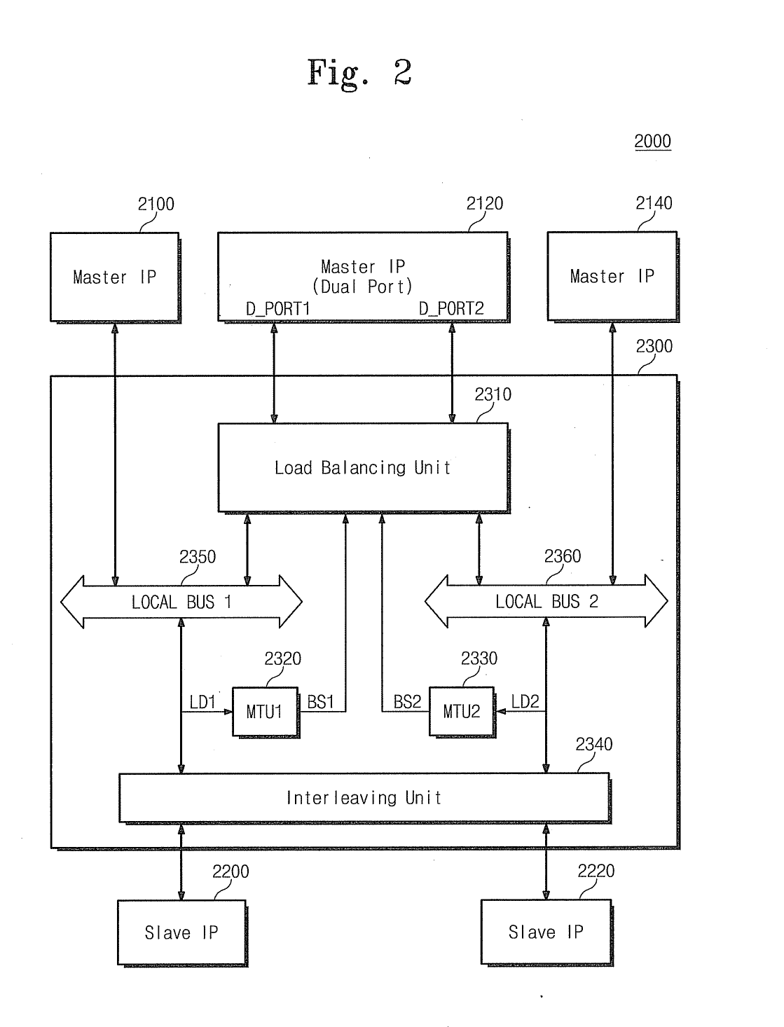

FIG. 2 is a block diagram illustrating a first embodiment of the SoC of FIG. 1 in more detail. Referring to FIG. 2, the SoC 2000 includes a plurality of master IP blocks 2100, 2120, and 2140, a plurality of slave IP blocks 2200 and 2220, and an interconnect block 2300. Hereinafter, overlapping description related to the SoC 1000 of FIG. 1 will be omitted.

In the first embodiment, at least one master IP block 2120 of the master IP blocks 2100, 2120, and 2140 outputs transactions through dual ports D_PORT1 and D_PORT2. Thus, the master IP block 2120 may increase a transmission bandwidth of transactions. For brief description, the master IP block 2120 having the dual ports D_PORT1 and D_PORT2 is called a first master IP block. Also, other master IP blocks 2100 and 2140 are called second and third master IP blocks, respectively.

The interconnect block 2300 includes a load balancing unit 2310, monitoring units 2320 and 2330, an interleaving unit 2340, and local buses 2350 and 2360.

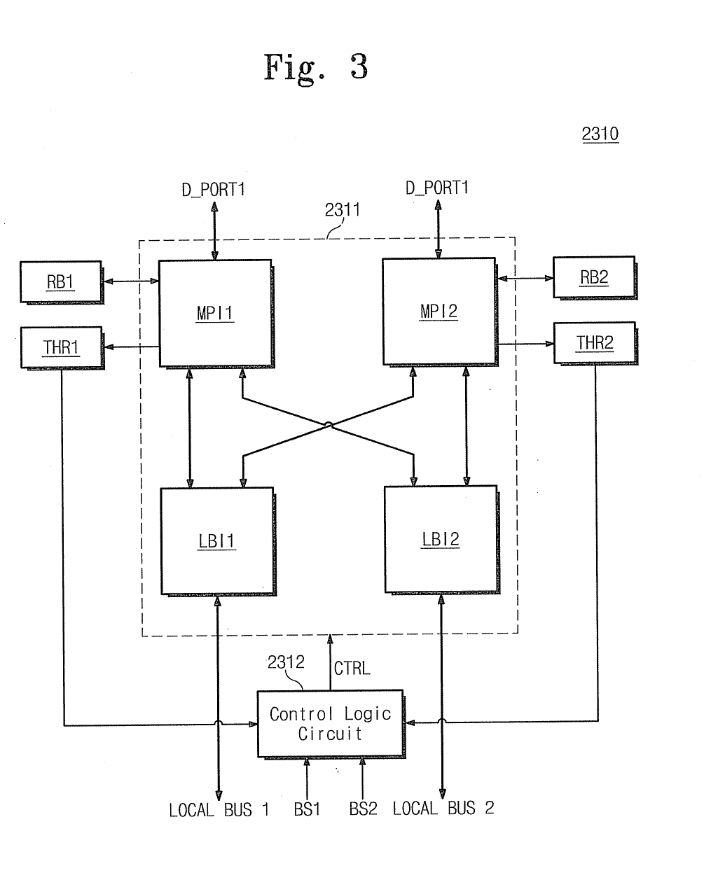

The load balancing unit 2310 operates in response to first and second busy signals BS1 and BS2 provided from the first and second monitoring units 2320 and 2330, respectively. The load balancing unit 2310 delivers transactions transmitted from the dual ports D_PORT1 and D_PORT2 of the master IP block 2120 to the first local bus 2350 and the second local bus 2360 according to which signal among the first and second busy signals BS1 and BS2 is activated. The load balancing unit 2310 according to the first embodiment will be described in more detail with reference to FIG. 3.

The first monitoring unit 2320 monitors first load information LD1 between the interleaving unit 2340 and the first local bus 2350. Here, the first load information LD1 means a delivery amount of transactions between the interleaving unit 2340 and the first local bus 2350. The first monitoring unit 2320 generates the first busy signal BS1 in comparison with a reference value that defines the first load information LD1. For example, if the first load information LD1 is more than the reference value, the first busy signal BS1 is activated.

The second monitoring unit 2330 monitors second load information LD2 between the interleaving unit 2340 and the second local bus 2360. Here, the second load information LD2 means a delivery amount of transactions between the interleaving unit 2340 and the second local bus 2360. The second monitoring unit 2330 generates the second busy signal BS2 in comparison with a reference value that defines the second load information LD2. For example, if the second load information LD2 is more than the reference value, the second busy signal BS2 is activated.

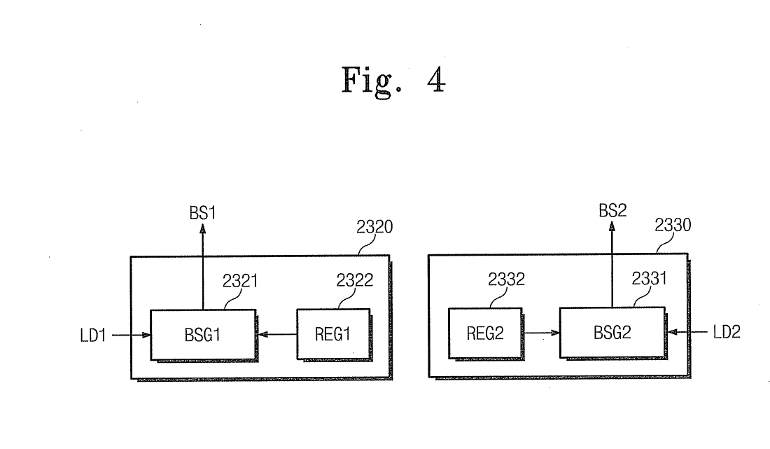

The first and second monitoring units 2320 and 2330 will be described in more detail with reference to FIG. 4.

The interleaving unit 2340 transmits transactions delivered from the first and second local buses 2350 and 2360 to the first slave IP block 2200 or the second slave IP block 2220. At this point, the interleaving unit 2340 selects one of the first and second slave IP blocks 2200 and 2220 according to a specific bit of a transaction address.

For example, the interleaving unit 2340 transmits transaction to the first slave IP block 2200 if the 12^{th} bit among transaction address 32 bits is 0 and transmits transaction to the second slave IP block 2200 if the 12^{th} bit among transaction address 32 bits is 1.

Moreover, as the inventors have discovered, when an amount of transaction delivered to the interleaving unit 2340 through respectively difference transfer paths becomes unbalanced, performance may be affected. To resolve this, the interconnect block 2300 according to an example embodiment of inventive concepts maintains load balance by delivering transactions through a transfer path of a relatively small load based on the load information LD1 and LD2 monitored in each transfer path.

FIG. 3 is a block diagram illustrating an example embodiment of the load balancing unit shown in FIG. 2. Referring to FIG. 3, the load balancing unit 2310 connected to a master IP block having dual ports D_PORT1 and D_PORT2 is shown. The load balancing unit 2310 includes an interface module 2311, a control logic circuit 2312, re-order buffers RB1 and RB2, and transfer history registers THR1 and THR2.

The interface module 2311 operates in response to a control signal CTRL of the control logic circuit 2312. The interface module 2311 includes master port interfaces MPI1 and MPI2 and local bus interfaces LBI1 and LBI2.

The first master port interface MPI1 connects the first port D_PORT1 of the master IP block with the first local bus interface LBI1 or the second local bus interface LBI2 according to a control signal CTRL.

The first master port interface MPI1 stores in the first re-order buffer RB1 the transactions delivered from the first and second local bus interfaces LBI1 and LBI2 in an un-matching response order about a request of a master IP block. In other words, the first re-order buffer RB1 stores the transactions from the first and second local bus interfaces LBI1 and LBI2 based on the order the transaction was delivered. Also, the first master port interface MPI1 transmits the transactions stored in the first re-order buffer RB1 to the first port D_PORT1 of a master IP block in a matching response order about a request of a master IP block. This is for preventing a deadlock phenomenon in which master IP blocks operate abnormally since any master IP block does not receive a response for a request.

The first master port interface MPI1 stores in the first transfer history register THR1 ID information and read/write information about transactions delivered to the first and second local bus interfaces LBI1 and LBI2. Here, the ID information classifies and represents which one of the first and second local bus interfaces LBI1 and LBI2 the transactions are delivered to, according to IDs of the transactions. Moreover, read/write information classifies and represents which one of the first and second local bus interfaces LBI1 and LBI2 the transactions are delivered to, according to whether the transactions are read or write transactions.

The second master port interface MPI2 connects the second port D_PORT2 of the master IP block with the first local bus interface LBI1 or the second local bus interface LBI2 according to a control signal CTRL.

The second master port interface MPI2 stores in the second re-order buffer RB2 the transactions delivered from the first and second local bus interfaces LBI1 and LBI2 in an un-matching response order about a request of a master IP block. In other words, the second re-order buffer RB2 stores the transactions from the first and second local bus interfaces LBI1 and LBI2 based on the order the transaction was delivered. Also, the second master port interface MPI2 transmits the transactions stored in the second re-order buffer RB2 to the second port D_PORT2 of a master IP block in a matching response order about a request of a master IP block.

The second master port interface MPI2 stores in the second transfer history register THR2 the ID information and read/write information about transactions delivered to the first and second local bus interfaces LBI1 and LBI2. Hereinafter, overlapping description related to the first master port interface MPI1 will be omitted for the sake of brevity.

The first local bus interface LBI1 connects the first local bus with the first master port interface MPI1 or the second master port interface MPI2 according to a control signal CTRL. The second local bus interface LBI2 connects the second local bus with the first master port interface MPI1 or the second master port interface MPI2 according to a control signal CTRL.

The control logic circuit 2312 generates a control signal CTRL for controlling the interface module 2311. The control logic circuit 2312 controls the interface module 2311 based on the first and second busy signals BS1 and BS2 provided from the first and second monitoring units and the ID information and read/write information stored in the first and second transfer history registers THR11 and THR2.

The control logic circuit 2312 controls the connection between the master port interfaces MPI1 and MPI2 and the local bus interfaces LBI1 and LBI2 according to which signal among the first and second busy signals is activated. For example, when the first busy signal BS1 is activated, the control logic circuit 2312 controls the interface module 2311 to allow the master port interfaces MPI1 and MPI2 to be connected to the second local bus interface LBI2. When the second busy signal BS2 is activated, the control logic circuit 2312 controls the interface module 2311 to allow the master port interfaces MPI1 and MPI2 to be connected to the first local bus interface LBI1. Thus, transactions transmitted from the dual ports D_PORT1 and D_PORT2 of a master IP block may be delivered through a transfer path of a relatively small load.

However, if the first and second busy signals BS1 and BS2 are all activated or deactivated, the control logic circuit 2312 controls the interface module 2311 according to a policy defined based on the ID information or read/write information stored in the first and second transfer history registers THR1 and THR2.

FIG. 4 is a block diagram illustrating the first and second monitoring units 2320 and 2330 shown in FIG. 2. Referring to FIG. 4, the first monitoring unit 2320 includes a first busy signal generator 2321 and a first register 2322 storing a defined reference value. The first busy signal generator 2321 compares monitored first load information LD1 with the reference value stored in the first register 2322 to generate a first busy signal BS1. The first busy signal BS1 is provided to the load balancing unit 2310.

The second monitoring unit 2330 includes a second busy signal generator 2331 and a second register 2332 storing a defined reference value. The second busy signal generator 2331 compares monitored second load information LD2 with the reference value stored in the second register 2332 to generate a second busy signal BS2. The second busy signal BS2 is provided to the load balancing unit 2310.

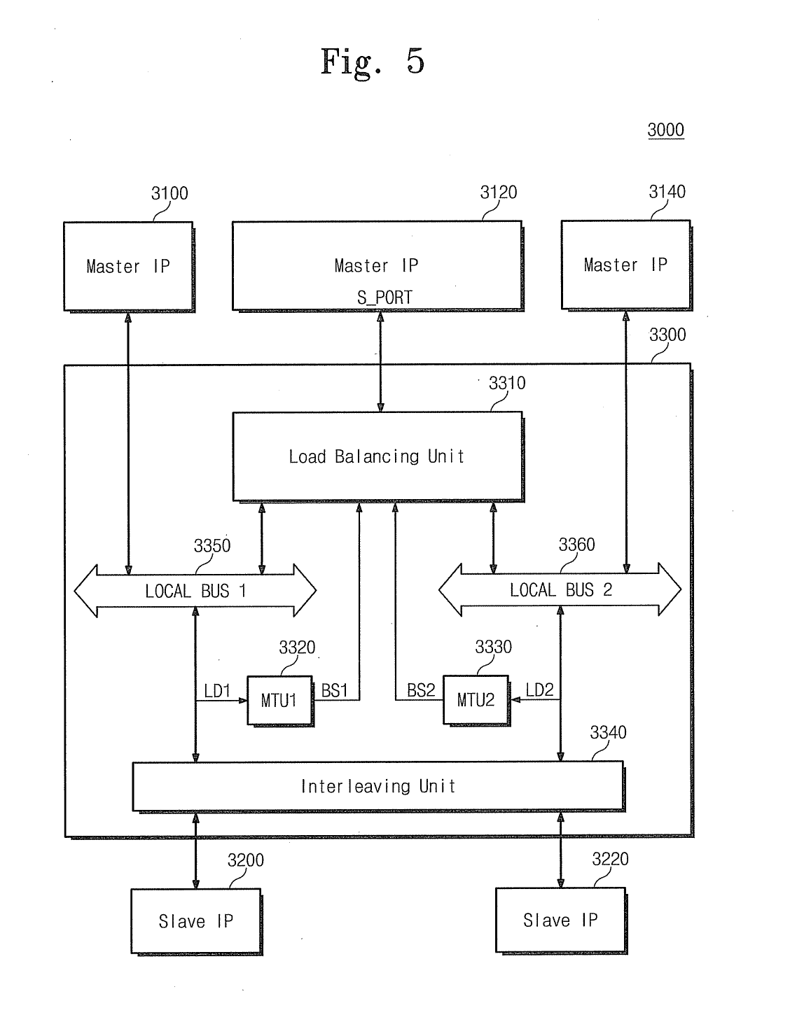

FIG. 5 is a block diagram illustrating another example embodiment of the SoC of FIG. 1 in more detail. Referring to FIG. 5, the SoC 3000 includes a plurality of master IP blocks 3100, 3120, and 3140, a plurality of slave IP blocks 3200 and 3220, and an interconnect block 3300. Hereinafter, overlapping description related to the SoCs 1000 and 2000 of FIGS. 1 and 2 will be omitted.

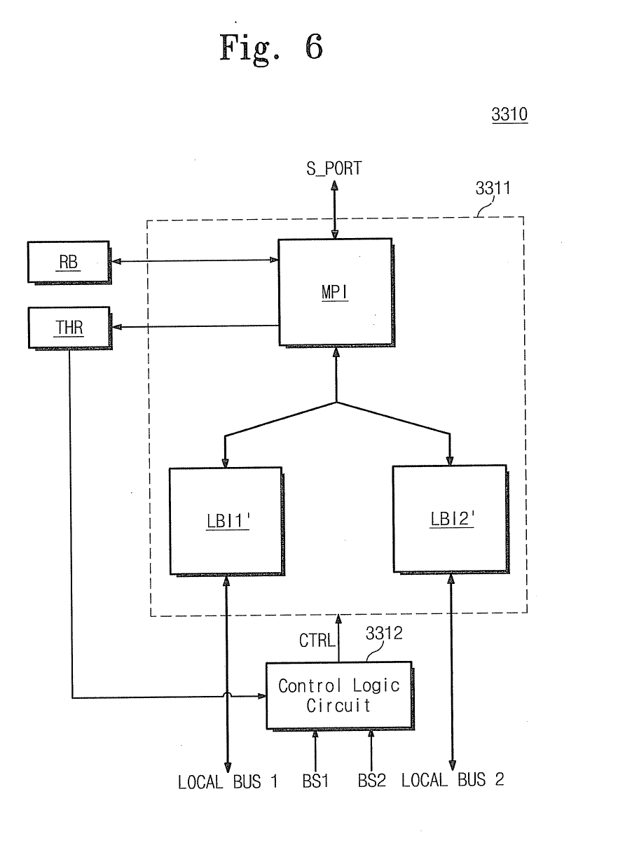

Unlike the first embodiment, a load balancing unit 3310 in the interconnect block 3300 is connected to a single port S_PORT of at least one master IP block 3120. That is, the load balancing unit 3310 divides transactions transmitted from a single port S_PORT of the master IP block 3120 to provide load balancing between transfer paths and then delivers the divided transactions to a first local bus 3350 or a second local bus 3360. The load balancing unit 3310 connected to a single port S_PORT of a master IP block 3120 will be described in more detail with reference to FIG. 6.

FIG. 6 is a block diagram illustrating the load balancing unit of FIG. 5. Referring to FIG. 6, a load balancing unit 3310 connected to a master IP block having a single port S_PORT is shown. The load balancing unit 3310 includes an interface module 3311, a control logic circuit 3312, a re-order buffer RB, and a transfer history register THR.

The interface module 3311 operates in response to a control signal CTRL of the control logic circuit 3312. The interface module 3311 includes a master port interface MPI and local bus interfaces LBI1′ and LBI2′.

The master port interface MPI connects the single port S_PORT of a master IP block with the first local bus interface LBI1′ or the second local bus interface LBI2′ according to the control signal CTRL.

The master port interface MPI stores in the re-order buffer RB the transactions delivered from the first and second local bus interfaces LBI1′ and LBI2′ in an un-matching response order about a request of a master IP block. In other words, the re-order buffer RB stores the transactions from the first and second local bus interfaces LBI1′ and LBI2′ based on the order the transaction was delivered. Also, the master port interface MPI transmits the transactions stored in the re-order buffer RB to the single port S_PORT of a master IP block in a matching response order about a request of a master IP block. This is for preventing the above mentioned deadlock phenomenon.

The master port interface MPI stores in the transfer history register THR ID information and read/write information about transactions delivered to the first and second local bus interfaces LBI1′ and LBI2′.

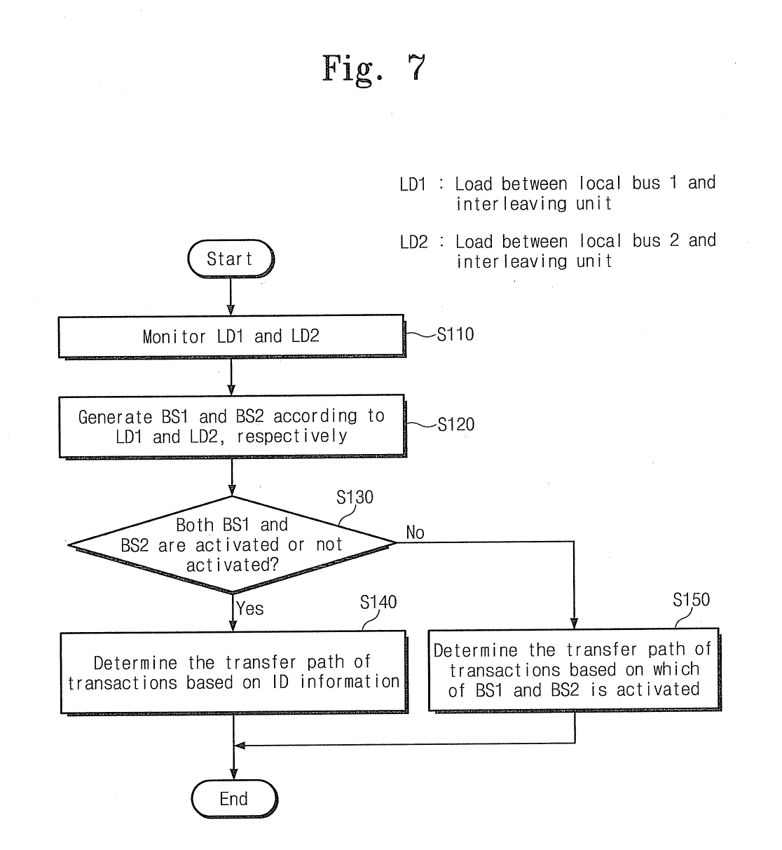

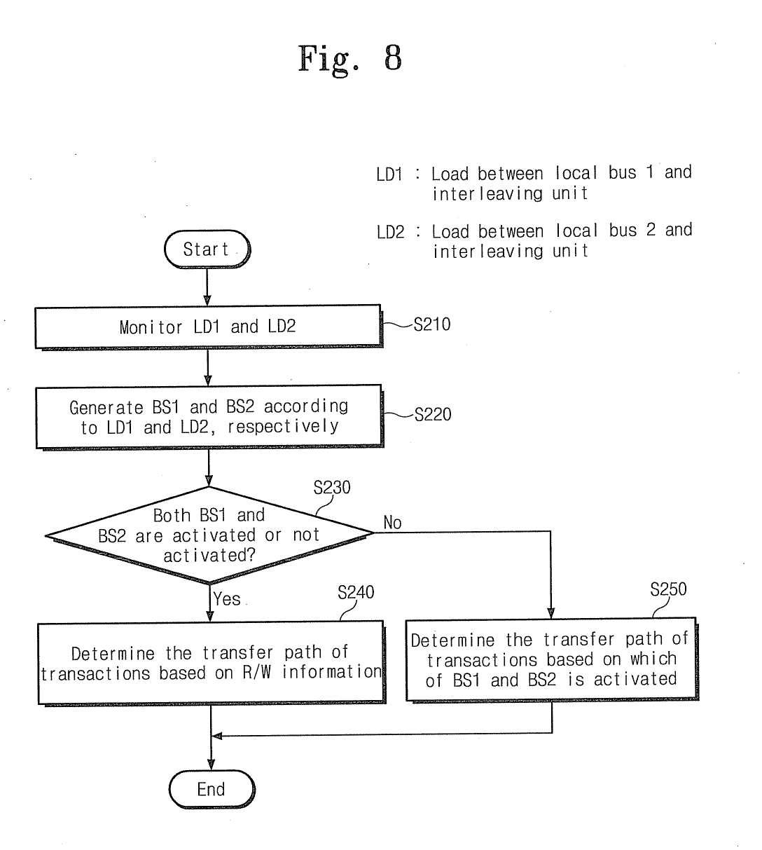

FIGS. 7 and 8 are flowcharts illustrating a method of maintaining a load balance of a SoC according to an example embodiment of inventive concepts. Referring to FIG. 7, first and second load information LD1 and LD2 are monitored in operation S110. As mentioned above, the first load information LD1 means a delivery amount of transactions between an interleaving unit and a first local bus (hereinafter, referred to as a first transfer path) and the second load information LD2 means a delivery amount of transactions between an interleaving unit and a second local bus (hereinafter, referred to as a second transfer path). That is, the first and second load information LD1 and LD2 represent load information of the first and second transfer path.

In operation S120, a first busy signal BS1 may be generated according to the first load information LD1 and a second busy signal BS2 may be generated according to the second load information LD2. For example, if the first and second load information LD1 and LD2 are more than a defined reference value, the first and second busy signals BSI and BS2 are activated.

In operation S130, is the load balancing unit determines that the first and second busy signals BS1 and BS2 are all activated or deactivated. If the first and second busy signals BS1 and BS2 are all activated or deactivated, operation S140 is performed. If not, operation S150 is performed.

In operation S140, if the first and second busy signals BS1 and BS2 are all activated or deactivated, a transfer path is determined by a policy defined based on ID information. As mentioned above, the ID information classifies and represents which one of the first and second transfer paths the transactions transmitted from a master IP block are delivered to, according to the IDs of the transactions. However, when it is before generating of ID information during an initial operation, a transfer path may be arbitrarily determined. Moreover, the transfer path may be determined based on defined initial ID information.

Hereinafter, an example policy for determining a transfer path based on ID information is described. For concise description, it is assumed that a transfer path for a second transaction is determined when a first transaction is already delivered through a first transfer path. If the first and second transactions have the same ID, they are delivered through the same transfer path. That is, the second transaction is delivered through the first transaction transfer path. On the contrary, if the first and second transaction IDs are different, they are delivered through respectively different transfer paths. That is, the second transaction is delivered through the second transaction transfer path. This is for preventing deadlock that may occur when transactions having the same ID are delivered through respectively different transfer paths.

In operation S150, if any one of the first and second busy signals BS1 and BS2 is activated, a transfer path is determined based on which signal of the first and second busy signals BS1 and BS2 is activated. For example, while the first busy signal BS1 is activated and the second busy signal BS2 is deactivated, transactions are delivered through the second transfer path. On the contrary, when the first busy signal BS1 is deactivated and the second busy signal BS2 is activated, transactions are delivered through the first transfer path.

Referring to FIG. 8, another example embodiment of a load balance maintaining method is described. Since operations S210, S220, S230, and S250 of FIG. 8 are identical to those S110, S120, S130, and S150 of FIG. 7, overlapping description will be omitted hereinafter.

In operation S240, when first and second busy signals BS1 and BS2 are all activated or deactivated, a transfer path is determined according to a policy defined based on read/write information. As mentioned above, the read/write information classifies and represents which one of the first and second transfer paths transactions transmitted from a master IP block are delivered to, according to whether transactions are read or write transactions. However, when it is before generating of the read/write information during an initial operation, a transfer path may be arbitrarily determined. Moreover, the transfer path may be determined based on defined initial read/write information.

Hereinafter, an example policy for determining a transfer path based on read/write information is described. For concise description, it is assumed that a transfer path for a second transaction is determined when a first transaction is already delivered through a first transfer path. If the first and second transactions are all read or write transactions, they are delivered through the same transfer path. That is, the second transaction is delivered through the first transaction transfer path. On the contrary, if the first transaction is a read (or write) transaction and the second transaction is a write (or read) transaction, the first and second transactions are delivered through respectively different transfer paths. That is, the second transaction is delivered through the second transaction transfer path. This is for reducing overhead that occurs since characteristics of transactions delivered through a transfer path are frequently changed.

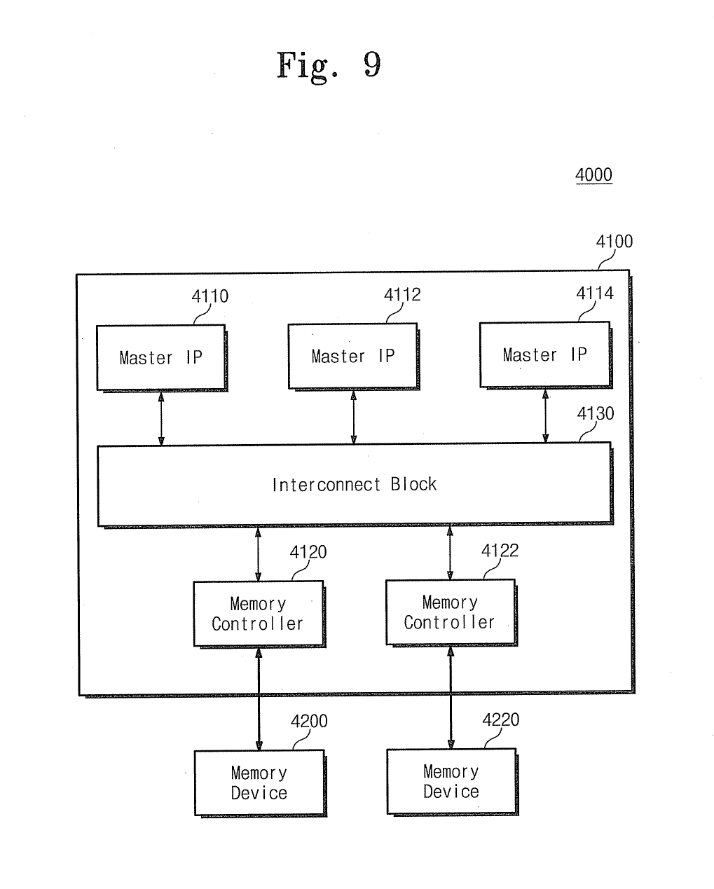

FIG. 9 is a block diagram of a memory system including a SoC according to an example embodiment of inventive concepts. Referring to FIG. 9, the memory system 4000 includes a SoC 4100 and memory devices 4200 and 4220.

The SoC 4100 includes a plurality of master IP blocks 4110, 4112, and 4114, a plurality of memory controllers 4120 and 4122, and an interconnect block 4130. Here, the memory controllers 4120 and 4122 serve as slave IP blocks. The first memory controller 4120 controls a first memory device 4200 and the second memory controller 4122 controls a second memory device 4220. Hereinafter, overlapping description related to the SoC 1000 of FIG. 1 will be described.

When at least one of the master IP blocks 4110, 4112, and 4114 transmits transactions to the plurality of memory controllers 4120 and 4122 through respectively different transfer paths in the interconnect block 4130, the interconnect block 4130 monitors load information of each transfer path. Then, the interconnect block 4130 selects a transfer path according to a monitoring result so that load balance may be maintained between transfer paths.

The memory devices 4200 and 4220 may be realized with nonvolatile memory devices such as a flash memory, Read Only Memory (ROM), Programmable ROM (PROM)), Erasable Programmable ROM (EPROM), Electrically Erasable Programmable ROM (EEPROM), Magnetic Random Access Memory (MRAM), Programmable RAM (PRAM), Resistive RAM (RRAM), and Ferroelectric RAM (FRAM). Moreover, the memory devices 4200 and 4220 may be realized with volatile memory devices such as Static RAM (SRAM), Dynamic RAM (DRAM), and Synchronous Dynamic RAM (SDRAM).

According to an example embodiment of inventive concepts, the performance of a SoC is improved and usage utilization of an interconnect block is improved by maintaining a load balance between transaction transfer paths using monitored load information.

The above-disclosed subject matter is to be considered illustrative and not restrictive, and the appended claims are intended to cover all such modifications, enhancements, and other embodiments, which fall within the true spirit and scope of inventive concepts. Thus, to the maximum extent allowed by law, the scope of inventive concepts is to be determined by the broadest permissible interpretation of the following claims and their equivalents, and shall not be restricted or limited by the foregoing detailed description.

What is claimed is:

1. A System on Chip (SoC) comprising:
a master block;
a plurality of slave blocks configured to operate in response to a request from the master block; and
an interconnect block configured to deliver transactions occurring in the master block to the plurality of slave blocks through a plurality of transfer paths,
wherein the interconnect block is configured to monitor load information of the plurality of transfer paths and select one of the plurality of transfer paths according to the load information.

2. The SoC of claim 1, wherein the interconnect block comprises:
a first monitoring unit configured to monitor load information of a first transfer path among the plurality of transfer paths and generate a first busy signal based on the load information of the first transfer path;
a second monitoring unit configured to monitor load information of a second transfer path among the plurality of transfer paths and generate a second busy signal based on the load information of the second transfer path; and
a load balancing unit configured to select one of the first and second transfer paths according to the first and second busy signals.

3. The SoC of claim 2, wherein the load balancing unit is configured to select the second transfer path if the first busy signal is activated and select the first transfer path if the second busy signal is activated.

4. The SoC of claim 3, wherein the load balancing unit comprises:
a transfer history register configured to store ID information and read/write information about the transactions, and select one of the first and second transfer paths based on one of the ID information and the read/write information if the first and second busy signals are all one of activated and deactivated.

5. The SoC of claim 2, wherein the interconnect block comprises:
an interleaving block configured to transmit the transactions to a slave block selected based on a transaction address among the plurality of slave blocks.

6. The SoC of claim 1, wherein the master block is configured to output the transactions through a dual port.

7. A System on Chip (SoC) comprising:
a master block;
a plurality of slave blocks configured to operate in response to a request of the master block; and
an interconnect block configured to connect the master block with the plurality of slave blocks,
wherein the interconnect block includes,
a load balancing unit configured to deliver transactions transmitted from the master block to a transfer path selected according to first and second busy signals among first and second transfer paths,
a first monitoring unit configured to generate the first busy signal based on load information of the first transfer path,
a second monitoring unit configured to generate the second busy signal based on load information of the second transfer path, and
an interleaving block configured to transmit transactions delivered from the load balancing unit through the first and second transfer paths to one of the plurality of slave blocks selected based on a transaction address.

8. The SoC of claim 7, wherein the load balancing unit comprises:
a control logic circuit configured to generate a control signal in response to the first and second busy signals; and
interface modules configured to deliver transactions transmitted from the master block to a transfer path selected according to the control signal among the first and second transfer paths.

9. The SoC of claim 8, wherein the load balancing unit is configured to select the second transfer path if the first busy signal is activated and the second busy signal is deactivated, and
select the first transfer path if the first busy signal is deactivated and the second busy signal is activated.

10. The SoC of claim 8, wherein the load balancing unit further comprises:
a transfer history register configured to store ID information and read/write information about transactions delivered through the selected transfer path.

11. The SoC of claim 10, wherein the control logic circuit is configured to generate the control signal based on the ID information or the read/write information if the first and second busy signals are activated or deactivated.

12. The SoC of claim 8, wherein the load balancing unit further comprises:
a re-order buffer configured to store transactions in the interface module through the first and second transfer paths, the re-order buffer configured to store the transactions not matching a response order for a request of the master block.

13. The SoC of claim 12, wherein the interface module is configured to transmit the transactions stored in the re-order buffer to the master block in a matching response order regarding the request of the master block.

14. The SoC of claim 8, wherein the master block is configured to transmit transactions to the interface module through a dual port.

15. The SoC of claim 7, wherein each of the plurality of slave blocks comprises a memory controller.

16. A system on chip (SoC) comprising:
at least one master block configured to generate a request;
an interconnect block including at least first and second transfer paths, the interconnect block configured to receive the request and transmit the request over one of the first and second transfer paths based on load information of the first and second transfer paths, the load information indicating an amount of traffic on the first and second transfer paths; and
at least one slave block configured to receive the request from the interconnect block.

17. The SoC of claim 16, wherein the interconnect block includes,
a load balancing unit configured to receive the request from the at least one master block and transmit the request over one of the first and second transfer paths based on first and second busy signals,
a first monitoring unit configured to receive the load information of the first transfer path and generate the first busy signal based on the load information of the first transfer path, and
a second monitoring unit configured to receive the load information of the second transfer path and generate the second busy signal based on the load information of the second transfer path.

18. The SoC of claim 17, wherein the load balancing unit includes,
an interface module configured to transmit the request over one of the first and second transfer paths and identification information of the request to a transfer history register, the identification information identifying one of the first or second transfer paths, the interface module configured to transmit the request over one of the first and second transfer paths based on the identification information if the first and second busy signals are activated, and
the transfer history register.

19. The SoC of claim 17, wherein the load balancing unit includes,
an interface module configured to transmit the request over one of the first or second transfer paths, the interface module is further configured to transmit read and write information of the request to a transfer history register, the read information associated with the first transfer path and the write information associated with the second transfer path, the interface module configured to transmit the request over one of the first and second transfer paths based on the read and write information if the first and second busy signals are activated, and
the transfer history register.
